(19) United States
(12) Patent Application Publication
(10) Pub. No.: US 2012/0043282 A1
(43) Pub. Date: Feb. 23, 2012

(54) METHOD AND APPARATUS FOR WASH WATER TREATMENT

(76) Inventor: Jerome Przecop, Novi, MI (US)

(21) Appl. No.: 12/859,142

(22) Filed: Aug. 18, 2010

(51) Int. Cl. C02F 1/00; B01D 35/143; B01D 35/02; B01D 37/00; B01D 37/04

(52) U.S. Cl. 210/744; 210/767; 210/806; 210/416.1; 210/85

(57) ABSTRACT

A waste water treatment apparatus includes a first reservoir for storing waste water interconnected to a second reservoir to receive and store treated water from the first reservoir upon activation of a pump. Operating the waste water treatment apparatus includes receiving waste water in the first reservoir, pumping the waste water from the first reservoir to the second reservoir, filtering the waste water from the first reservoir creating treated water prior to being received in the second reservoir, and using the treated water for cleansing.

### TECHNICAL FIELD

This disclosure is related to waste water treatment apparatuses, and particularly to those that treat wash water.

### BACKGROUND

The statements in this section merely provide background information related to the present disclosure and may not constitute prior art. As the environment becomes an increasing concern, regulations are becoming more stringent with respect to handling waste. In particular, municipal water treatment facilities are requiring industrial and other commercial facilities to treat wastewater, such as water used in cleaning floors or other surfaces, outside of the municipal water treatment facilities. Some industrial facilities have the capability to treat wastewater on-site but many do not. Therefore, the industrial facilities have the wastewater stored, removed, and treated off-site. This can be costly for the storage facilities as the storing and shipping of wastewater may occur as frequently as daily or weekly depending upon on-site storage capabilities.

Typically, if a waste water treatment facility is a part of the facility, it is located in separate building. Therefore, it is necessary to transport the waste water to the facility when the water is no longer in use. This may be pumped to the facility or stored and delivered on regular intervals. Known facilities treat water to or near drinking water quality with a focus on removing all or nearly all contaminates from the water.

### SUMMARY

A waste water treatment apparatus includes a first reservoir for storing waste water interconnected to a second reservoir to receive and store treated water from the first reservoir upon activation of a pump. Operating the waste water treatment apparatus includes receiving waste water in the first reservoir, pumping the waste water from the first reservoir to the second reservoir, filtering the waste water from the first reservoir creating treated water prior to being received in the second reservoir, and using the treated water for cleansing.

### BRIEF DESCRIPTION OF THE DRAWINGS

One or more embodiments will now be described, by way of example, with reference to the accompanying drawings, in which:

FIG. 1 schematically illustrates a transportable waste water treatment apparatus for treating waste water by separating desirable water and cleansing agents from undesirable dirt and oils in accordance with the present disclosure; and

FIG. 2 depicts an exploded and partial sectional view of the waste water treatment apparatus in accordance with the present disclosure.

### DETAILED DESCRIPTION

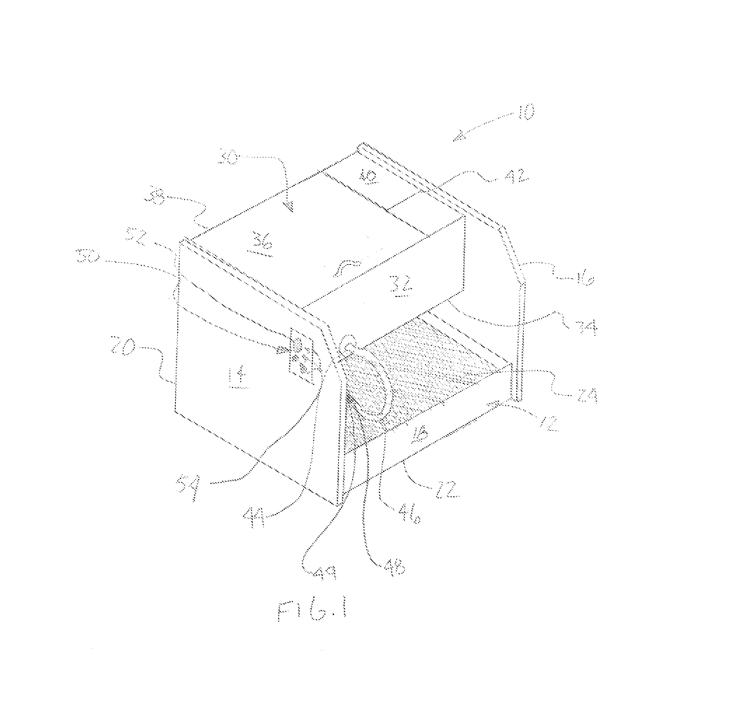

Referring now to the drawings, wherein the showings are for the purpose of illustrating certain exemplary embodiments only and not for the purpose of limiting the same, FIG. 1 schematically illustrates a transportable waste water treatment apparatus 10 for treating waste water by separating desirable water and cleansing agents from undesirable dirt and oils. The waste water treatment apparatus 10 includes a waste water reservoir 12, a first side 14, a second side 16, and a treated water reservoir 30. The waste water reservoir 12 is a watertight storage tank created from the first side 14, the second side 16, a front 18, a base 22, and a back 20. The waste water reservoir 12 additionally includes grating 24 interconnecting the first side 14, the second side 16, the front 18, and the back while being distally spaced from the bottom 22. The grating 24 allows water to pass into the waste water reservoir 12 while keeping large particulate from entering the waste water reservoir 12. The grating 24 can be wholly or partially removable to provide access to the waste water reservoir 12. It will be apparent to one of ordinary skill in the art that partially removable grating 24 includes a hinged or removable panel portion without varying from the scope of the invention. It will also be apparent that the waste water reservoir 12 can be a separately removable reservoir that is placed within a framework of the waste water treatment apparatus 10 without varying from the scope of the invention.

The treated water reservoir 30 is generally an enclosed watertight storage tank created from the first side 14, the second side 16, a front 32, a base 34, a top 36, and a back 38. The top 36 includes an access door 39 for accessing the treated water reservoir 30 and a filter door 40 for accessing a filter compartment 42. An outlet 44 is attached on or near the base 34 for providing a flow of treated water. The outlet 44 can provide treated water flow from a gravity feed and manual or electrically operated outlet pump by way of a transfer hose 46. The transfer hose 46 includes an outlet 48 that can have a nozzle 49 attached thereto for controlling the flow of treated water. It will be apparent to one of ordinary skill in the art that the treated water reservoir 30 can be a separately removable reservoir that is placed within a framework of the waste water treatment apparatus 10 without varying from the scope of the invention. Watertight reservoirs means designed to prevent water from leaking from either waste water reservoir 12 or treated water reservoir 30. The reservoirs 12 and 30 can be welded panels of coated steel, aluminum, or other metallic substance, can be produced with various types of molded plastic, and/or lined with rubber or plastic material such that water impermeability and corrosion resistance is assured.

A control panel 50 is positioned for easy access by a user, e.g., on the first side 14, second side 16, front 32, and a separate panel adjacent the front 32. The control panel 50 can include a warning identifier 52, such as a visual indicator or audible indicator, for creating a notification(s) related to the operation of the waste water treatment apparatus 10. The control panel 50 can also include switchable controls 54 for independently activating various components of the waste water treatment apparatus 10 as will be detailed below.

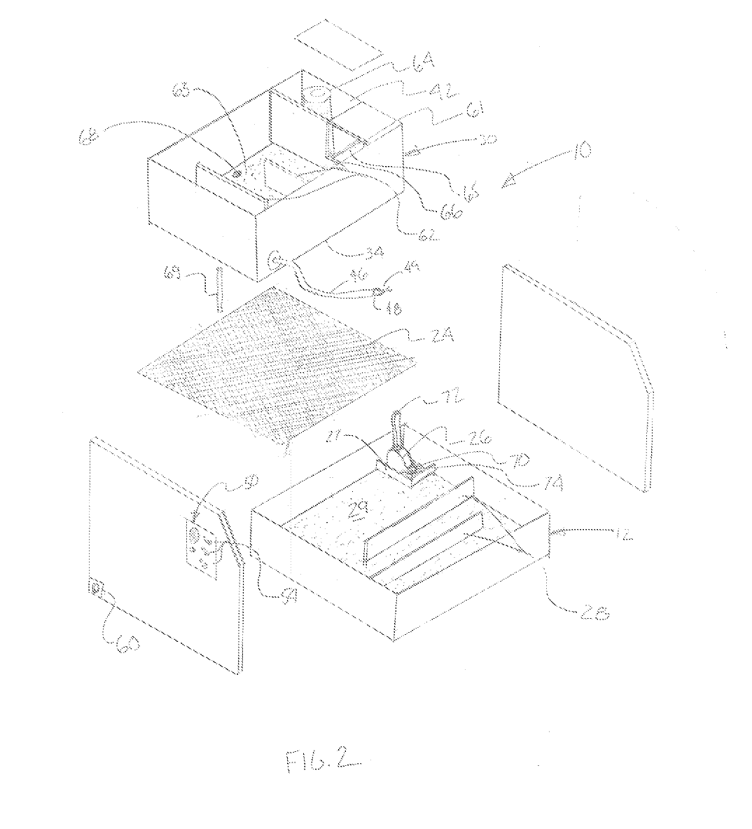

FIG. 2 depicts an exploded view of the waste water treatment apparatus 10. The waste water reservoir 12 includes a transfer pump 26 for transferring water stored in the waste water reservoir 12 to the treated water reservoir 30. The transfer pump 26 is actuated internally when a certain amount of waste water has been stored in the waste water reservoir 12 or actuated by one of the switchable controls 54 located on the control panel 50. The transfer pump 26 includes an inlet 70 and an outlet 72. The inlet 70 can include a screen 74 for preventing particulate matter capable of entering the waste water reservoir 12 through the grating 24 from entering the pump 26. The outlet 72 directs water flow from the waste water reservoir 12 to the treated water reservoir 30 and particularly to the filter compartment 42.

The waste water storage tank 12 can include a plurality of baffles 28 to slow entering water flow from the front of the waste water storage tank 12 to the rear, and particularly, to the pump 26. The pump 26 is surrounded by a low baffle 27 to prevent settled particulate from entering the pump when activated. Slowing entering water from the front assists in separating solid particulate from the waste water. The baffles 28 are a series of walls capable of slowing waste water flow down. A particulate separation panel 29 can be placed above the base 22. The particulate separation panel 29 has a plurality of apertures to allow the solid particulate to precipitate out of the waste water. It will be appreciated that the baffles 28 and the separation panel 29 can be used individually or in combination. It will be recognized when the separation panel 29 is utilized, a clean-out panel can be fitted to facilitate the removal of the settled solid particulate. The waste water storage tank 12 includes a clean-out outlet 60 for facilitating waste water removal when necessary. The clean-out outlet 60 may be actuated by a manual valve or electrically operated valve actuated by one of the switchable controls 54 located on the control panel 50.

The treated water reservoir 30 includes the filter compartment 42 that houses a filter element 64. The filter compartment 42 includes a low baffle wall 65 to permit water to exit the filter compartment 42 and into a holding tank 61. The holding tank 61 includes a slightly taller baffled wall 66 to slow the filtered water flow down from the filter compartment 42 to the treated water reservoir 30. The holding tank 61 assists in settling out any particulate matter that may have passed through the filter element 64.

The filter element 64 is generally cylindrical and positioned within the filter compartment 42 for filtering the waste water pumped from the waste water reservoir 12 before entering the treated water reservoir 30. The filter element 64 can include different flow rates such as a high flow filter element, e.g., capable of filtering approximately 13.6 liters per minute, or a low flow filter element, e.g., capable of filtering approximately 2.3 liters per minute. The filter element 64 being the high flow element can have a filtering capacity of, e.g., 1, 3, or 5 microns, and the filter element 64 being the low flow element can have a filtering capacity of, e.g., 1 micron. The pump 26 also has a flow rate that can be tailored to the filter flow rates that can be selectable by one of the switchable controls 54 on the control panel 50 to match the filter element 64 being used. Alternatively, each waste water treatment apparatus 10 can be designed to operate in only one of high flow or low flow rates.

The filter element 64 in either the high flow or low flow rate is capable of filtering waste water, such as water used for cleaning, i.e., having a composition of a desirable component, e.g., cleansing agents and water, and an undesirable component, e.g., dirt and oils. The filter element 64 is capable of filtering out the undesirable components from the desirable components. Upon filtering the undesirable components, e.g., dirt and oils from the desirable components, e.g., cleansing agents and water, are stored within the treated water reservoir 30 for later disbursement when cleaning is desired.

The treated water reservoir 30 can include a plurality of baffles 62 to slow the water flow down from the filter compartment 42 to the outlet 44 to assist in separating solid particulate from the waste water. The baffles 62 are a series of walls capable of slowing waste water flow down. A particulate separation panel 63 above the base 34. The particulate separation panel 63 has a plurality of apertures to allow any remaining solid particulate to precipitate out of the filtered water. It will be recognized when the separation panel 63 is utilized, a clean-out panel can be fitted to facilitate the removal of the settled solid particulate. It will be appreciated that the baffles 62 and the separation panel 63 can be used individually or in combination. It will be recognized when the separation panel 63 is utilized, a clean-out panel can be fitted to facilitate the removal of the settled solid particulate.

The treated water reservoir 30 includes a treated water return 68. The treated water return 68 permits a small amount of treated water to flow from the treated water reservoir 30 in to the waste water reservoir 12. The flow can be automated, e.g., controlled by a mechanical or electrical timer to open a valve to allow flow during predetermined times, manually, e.g., operated by a switch 54 located on the control panel 50, and controlled by pressure, e.g., upon a certain volume of water entering the treated water reservoir 30 the pressure valve opens allowing water to flow. A flow tube 69 can be attached thereto to provide a directed flow of water. The constant rotation of water prevents stagnation of water in both the waste water reservoir 12 and the clean water reservoir 30. Preventing water from stagnating assists in maintaining acceptable storage of water.

The waste water treatment apparatus 10 can be used in commercial facilities such as industrial complexes, factories, or retail establishments where space is at a premium. The waste water treatment apparatus 10 can be positioned in an unobtrusive way as to not interfere with other functions of the facility. The volume of water to be treated from one facility to the next can be variable. The exemplary waste water treatment apparatus 10 holds a similar volume of fluid for the waste water reservoir 12 and the treated water reservoir 30, e.g., 662 liters, or can hold a differing amount of fluid, e.g., 549 and 662 liters respectively. A very large facility requiring additional fluid can have several waste water treatment apparatuses 10 next to each other, space them separately around the facility, or have larger capacity reservoirs attached thereto.

In use, a facility is cleansed, i.e., cleansing agents are added to dispensed water for manual, e.g., a mop and bucket, or assisted, e.g., industrial scrubbing machines, cleaning. Upon completion of cleansing, the waste water includes desirable components of, e.g., water and cleansing agents combined with undesirable components of, e.g., dirt and oils. The waste water may then be deposited in the waste water reservoir 12. Large particulate matter is filtered out by the grating 24 as the waste water passes through the grating 24 and into the waste water reservoir 12. The provided baffling 28 slows the flow of the waste water allowing for particulate matter to precipitate out of the waste water and be deposited on the base 22. The separation panel 29 maintains separation of the settled particulate matter from the waste water and prevents intake into the pump 26.

Upon reaching a certain level of waste water within the waste water reservoir 12, the transfer pump 26 is automatically activated to pump the waste water to the filter compartment 42. Alternatively, the transfer switch 54 can be activated by an operator to transfer the waste water in the waste water reservoir 12 to the filter compartment 42. It will be appreciated that with a manual switch a timer can be included to automatically terminate the transfer pump 26 operation upon reaching a preset time limit. The waste water is passed through the filter element 64 for removing the undesirable components of the waste water. The remaining waste water desirable components are passed through the filter element 64 as treated water to be stored in the treated water reservoir 30. Once the treated water reaches a certain level in the filter compartment 42, the treated water flows over the low baffle wall 65 and into the holding tank 61. The treated water reaches a predetermined volume in the holding tank 61 and passes over the slightly taller baffled wall 66 and into the waste water reservoir 30. The baffling 62 slows the flow of the treated water to permit any additional particulate matter to further precipitate out of the desirable components of the treated water.

When facility cleansing is again desired, treated water is transferred from the treated water reservoir 30 to a container for manual or assisted cleaning. The treated water is transferred by positioning the outlet 48 of the hose 46 to dispense the treated water into the manual or assisted cleaning containers. The treated water is transferred by either manually or by actuating one of the switchable controls 54. If a nozzle 49 is used, the nozzle 49 can be actuated to dispense the treated water. No additional cleansing agents are required to be added to the treated water as the desirable components of cleansing agents and water are transferred to the container.

The filter 42 is required to be changed based upon usage and can be dependant on time or volume of waste water treated. When the waste water treatment apparatus includes the warning identifier 52, the warning identifier 52 sets a warning either optically, audibly, or both when a computer, flow rate monitor, or manual timer activates the warning identifier 52. Otherwise, the filter 42 will be changed as identified by time, e.g., a number of days, and number of cycles the pump has been activated.

Changing the filter requires the opening of the filter door 40 and replacing the used filter with a replacement filter element 64. If the filter element 64 has a different flow rate characteristic, the appropriate pump flow rate can be selected by one of the switchable controls 54.

When the waste water treatment apparatus 10 is desired to be cleaned or the waste water is desired to be removed, a hose can be connected to the clean-out outlet 60. After the hose is connected, a clean-out valve is opened, either manually or actuated by one of the switchable controls 54, to dispense the waste water. Alternatively, the waste water may be removed by pumping out the waste water after removal of the grating 24 or opening the access panel. The treated water reservoir 30 may be emptied through outlet 44 or by being pumped out through access panel 62. The water removed from the waste water treatment apparatus 10 is stored in transportable tanks for removal to off-site treatment facilities. Alternatively, if removable waste and treated water reservoirs 12 and 30, respectively, are used for the waste water reservoir 12 and the treated water reservoir 30, the waste and treated water reservoirs 12, 30 can be removed and replaced with empty reservoirs 12, 30.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for operating a waste water treatment apparatus wherein a first reservoir for storing waste water is interconnected to a second reservoir to receive and store treated water from the first reservoir when a pump is actuated, wherein the method further comprises:
receiving waste water in the first reservoir;
pumping waste water from the first reservoir to the second reservoir;
filtering the waste water from the first reservoir to create treated water prior to being received in the second reservoir; and
using the treated water for cleansing.

2. The method of claim 1, wherein waste water comprises desirable components of water and cleansing agents combined with undesirable components of dirt and oils.

3. The method of claim 2, wherein filtering the waste water comprises separating the undesirable components of dirt and oils from the desirable components of water and cleansing agents.

4. The method of claim 3, wherein the desirable components of water and cleansing agents are stored within the second reservoir.

5. The method of claim 1, wherein the first reservoir includes baffling to separate particulate from the waste water.

6. The method of claim 1, wherein the second reservoir includes baffling to separate particulate from the waste water.

7. The method of claim 1, wherein pumping waste water from the first reservoir to the second reservoir occurs automatically upon reaching a predefined level of fluid in the first reservoir.

8. The method of claim 1, wherein pumping waste water from the first reservoir to the second reservoir occurs upon the activation of a switch.

9. The method of claim 1, wherein filtering the waste water from the first reservoir to create treated water includes utilizing a low flow filter and associated low flow pump.

10. The method of claim 1, wherein filter the waste water from the first reservoir to create treated water includes utilizing a high flow filter and associated high flow pump.

11. The method of claim 1, wherein pumping waste water from the first reservoir to the second reservoir includes a pump switchable between a low flow state and a high flow state.

12. The method of claim 1, wherein the second reservoir includes an outlet for controllably dispensing treated water into an additional container.

13. The method of claim 1, wherein the waste water treatment apparatus includes a control panel for activating pumps and outlets included within the waste water treatment apparatus.

14. The method of claim 13, wherein the control panel further comprises a warning identifier monitoring the usage of the waste water treatment apparatus to predict when a filter change is necessary.

15. The method of claim 1, wherein the waste water treatment apparatus further comprises a removable first reservoir and a removable second reservoir.

16. Apparatus for filtering waste water comprising a first reservoir interconnect to a second reservoir and a pump the apparatus comprising:
the first reservoir for accepting waste water to the apparatus;
waste water having undesirable components of dirt and oils and desirable components of water and cleansing agents;
a filter element located between the first reservoir and the second reservoir to separate undesirable components from the waste water leaving desirable components in treated water;
the second reservoir for accepting and storing treated water within the apparatus and including an outlet for dispensing the treated water; and
a control panel for operating the waste water apparatus.

17. The apparatus of claim 16, wherein the control panel for operating the waste water apparatus includes controls to operate valves and pumps included on the waste water apparatus.

18. The apparatus of claim 16, wherein the control panel for operating the waste water treatment apparatus includes a warning identifier to monitor the usage of the filter element.

19. The apparatus of claim 16, wherein the first reservoir and the second reservoir further comprises a series of baffles for separating particulate matter from the waste water and treated water.

20. The apparatus of claim 16, wherein the waste water treatment apparatus is switchable between a high flow and a low flow apparatus.
